(19) United States
(12) Patent Application Publication
(10) Pub. No.: US 2020/0283160 A1
(43) Pub. Date: Sep. 10, 2020

(54) AIRCRAFT PYLON FAIRING

(71) Applicant: BOMBARDIER INC., Dorval (CA)

(72) Inventors: Reza SADRI, Kirkland (CA); Kathleen DUSSAULT, Laval (CA); Edmond BOILEAU, Montreal (CA)

(21) Appl. No.: 16/756,515

(22) PCT Filed: Oct. 15, 2018
(86) PCT No.: PCT/CA2018/051293

§ 371 Date: Apr. 16, 2020

Related U.S. Application Data
(60) Provisional application No. 62/574,323, filed on Oct. 19, 2017.

(51) Int. Cl. B64D 27/26; B64D 27/18; B64D 29/02

(52) U.S. Cl. CPC B64D 27/26; B64D 2027/266; B64D 29/02; B64D 27/18

(57) ABSTRACT

An assembly comprises a wing and a pylon fairing extending from the wing at a pylon location. The pylon fairing has an aerodynamic profile defining a fairing trailing edge. The pylon fairing has an upper section extending from the wing and a lower section including a shelf. The aerodynamic profile of the upper section is cambered toward the root of the wing. The aerodynamic profile of at least part of the lower section is symmetrical. The fairing trailing edge in the upper section extends axially rearward of a trailing edge of the wing at the pylon location. In addition or alternately, a distance between the fairing trailing edge in the upper section and a trailing edge of the wing at the pylon location has a value corresponding to at most 30% of a local chord of the wing at the pylon location.

### CROSS-REFERENCE TO RELATED APPLICATION(S)

This International PCT Patent Application relies for priority on U.S. Provisional Patent Application Ser. No. 62/574,323 filed on Oct. 19, 2017, the entire content of which is incorporated herein by reference.

### TECHNICAL FIELD

The application relates generally to aircraft and, more particularly, to fairings disposed around pylons used for structurally linking an engine to a wing.

### BACKGROUND OF THE ART

Pylons are often disposed between a wing and an engine. To improve the aerodynamic characteristics, a pylon fairing is disposed around and/or defined by an outer layer (skin) of the pylon. The pylon fairing is typically streamlined to minimize aerodynamic losses. A plurality of different shapes of pylon fairings exist. Nevertheless, improvements are still possible.

### SUMMARY

In one aspect, there is provided an assembly for an aircraft comprising: a wing having a root configured to be adjacent a fuselage of the aircraft; and a pylon fairing extending from the wing at a pylon location spaced from the root, the pylon fairing having an aerodynamic profile defining a fairing trailing edge, an upper section adjacent the wing, and a lower section configured to be adjacent an engine of the aircraft, the lower section including a shelf configured for extending through a jet generated by the engine; wherein the aerodynamic profile in the upper section of the pylon fairing is cambered toward the root of the wing; wherein the aerodynamic profile in at least part of the lower section of the pylon fairing is symmetrical; and wherein the fairing trailing edge in the upper section of the pylon protrudes rearwardly of a trailing edge of the wing at the pylon location.

In particular embodiments, the assembly may include any one or any combination of the following:
the at least part of the lower section of the fairing has a chord line configured to be parallel to a central axis of the engine, the fairing trailing edge in the upper section being offset from a plane containing the chord line of the lower section and the central axis of the engine by an offset distance having a value corresponding to at least 0.3% of a local chord of the wing at the pylon location;
the value of the offset distance between the fairing trailing edge in the upper section and the plane corresponds to at most 6.5% of the local chord of the wing at the pylon location;
a value of a distance between the trailing edge of the wing and the fairing trailing edge at the pylon location corresponds to at least 3% of a local chord of the wing at the pylon location;
the value of the distance between the trailing edge of the wing and the fairing trailing edge at the pylon location corresponds to at most 13% of the local chord of the wing at the pylon location;
the pylon fairing has opposed inward and outward sides with the inward side facing the root of the wing, the outward side of the upper section of the pylon fairing being convex and the inward side of the upper section of the pylon fairing being concave;
the pylon fairing further comprises a central section between the upper and the lower sections, the central section cambered toward the root of the wing, the fairing trailing edge in the central section being forwardly offset from the fairing trailing edge in the upper section;
a height of the upper section defined from the wing to the central section has a value corresponding to at least 2.5% of a local chord of the wing at the pylon location;
the value of the height of the upper section is at most 10% of the local chord of the wing at the pylon location.

In another aspect, there is provided an assembly for an aircraft comprising: a wing having a root configured to be adjacent a fuselage of the aircraft; and a pylon fairing extending from the wing at a pylon location spaced from the root, the pylon fairing having an aerodynamic profile defining a fairing trailing edge, an upper section extending from the wing, and a lower section configured to be adjacent an engine of the aircraft and including a shelf configured for extending through a jet generated by the engine; wherein at least part of the lower section of the fairing has a chord line configured to extend in an engine vertical mid-plane of the engine, the fairing trailing edge in the at least part of the lower section being contained within the engine vertical mid-plane; wherein the fairing trailing edge in the upper section is offset from the engine vertical mid-plane and located between the engine vertical mid-plane and the root of the wing; and wherein a distance between the fairing trailing edge in the upper section and a trailing edge of the wing at the pylon location has a value corresponding to at most 30% of a local chord of the wing at the pylon location.

In particular embodiments, the assembly may include any one or any combination of the following:
the fairing trailing edge in the upper portion is offset from the engine vertical mid-plane by an offset distance having a value corresponding to at least 0.3% of the local chord of the wing at the pylon location;
the value of the offset distance between the fairing trailing edge in the upper portion and the engine vertical mid-plane corresponds to at most 6.5% of the local chord of the wing at the pylon location;
the fairing trailing edge in the upper section is located forward of the trailing edge of the wing, or the fairing trailing edge in the upper section is axially aligned with the wing trailing edge at the pylon location;
the pylon fairing has opposed inward and outward sides with the inward side facing the root of the wing, the outward side of the upper section of the pylon fairing being convex and the inward side of the upper section of the pylon fairing being concave;
the pylon fairing further comprises a central section between the upper and the lower sections, the central section cambered toward the root of the wing, the fairing trailing edge in the central section forwardly offset from the fairing trailing edge in the upper section and from the trailing edge of the wing;
the value of the distance between the trailing edge of the wing and the fairing trailing edge at the pylon location corresponds to at least 3% of the local chord of the wing at the pylon location;
the value of the distance between the trailing edge of the wing and the fairing trailing edge at the pylon location corresponds to at most 13% of the local chord of the wing at the pylon location.

In another aspect, there is provided a method of directing an airflow around an aircraft between a wing of the aircraft and an engine connected to the wing, comprising: guiding the airflow toward a trailing edge of the wing between a pylon supporting the engine and a fuselage of the aircraft with a fairing of the pylon, wherein guiding the airflow includes: deviating an upper portion of the airflow adjacent the wing toward the fuselage with the fairing, the pylon fairing deviating the flow up to a trailing edge of the pylon fairing spaced rearwardly from the trailing edge of the wing, and guiding a portion of a jet generated by the engine with the fairing along a direction parallel to a central axis of the engine.

In a particular embodiment, a value of a distance between the trailing edge of the wing and the fairing trailing edge adjacent the wing corresponds to at least 3% of a local chord of the wing adjacent the pylon.

### DESCRIPTION OF THE DRAWINGS

For a better understanding of the present invention, as well as other aspects and further features thereof, reference is made to the following description which is to be used in conjunction with the accompanying drawings, where:

FIG. 1 is a schematic tridimensional view of an aircraft;

FIG. 2 is a schematic bottom view of an engine suspended below a wing of the aircraft of FIG. 1 via a pylon surrounded by a fairing in accordance with a particular embodiment;

FIG. 3 is a schematic side view of the engine and pylon fairing of FIG. 2;

FIG. 4 is a schematic cross-sectional bottom view of the pylon fairing of FIG. 2;

FIG. 5 is a schematic enlarged view of area Z5 of FIG. 4;

FIG. 6 is a schematic enlarged view of area Z6 of FIG. 4;

FIG. 7 is a graph illustrating a variation of an offset of a trailing edge of the pylon fairing of FIG. 2 relative to the engine vertical mid-plane as a function of a distance from a lower surface of the wing;

FIG. 8 is a graph illustrating a variation of an axial distance between a trailing edge of the wing and the trailing edge of the pylon fairing as a function of the distance from the lower surface of the wing;

FIG. 9 is a schematic bottom view of the engine suspended below the wing of the aircraft of FIG. 1 via a pylon fairing in accordance with another particular embodiment;

FIG. 10 is a schematic side view of the engine and the pylon fairing of FIG. 9;

FIGS. 11a to 11c are schematic cross sectional views of pylon fairings in accordance with other embodiments; and

FIG. 12 is a schematic cross sectional view of a pylon fairing in accordance with another embodiment.

In the drawings, embodiments of the invention are illustrated by way of example. It is to be expressly understood that the description and drawings are only for purposes of illustration and as an aid to understanding. They are not intended to be a definition of the limits of the invention.

### DETAILED DESCRIPTION

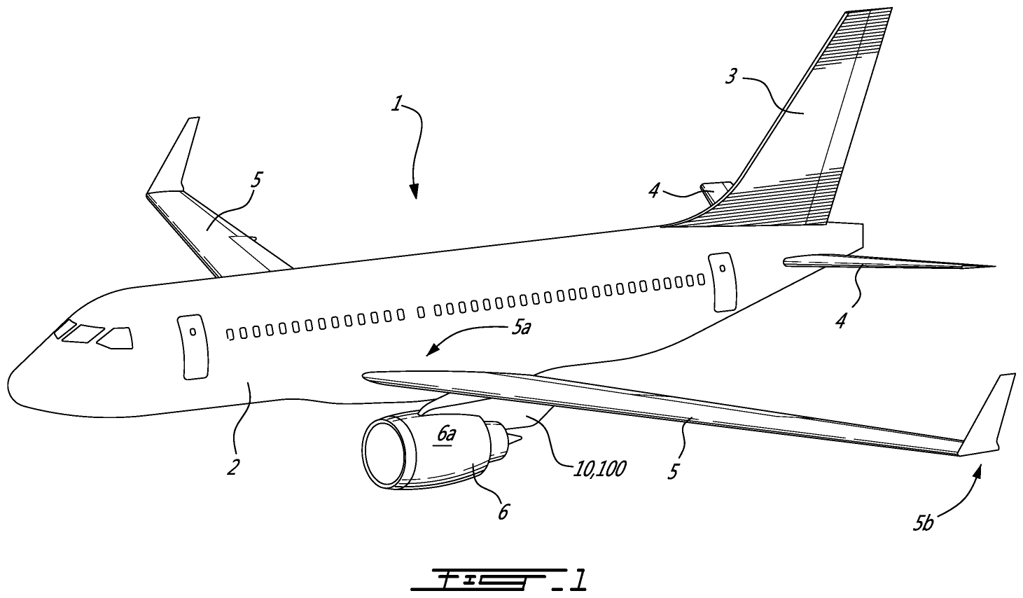

Referring to the drawings and more particularly to FIG. 1, an aircraft is shown at 1, and is generally described to illustrate some components for reference purposes in the present disclosure. The aircraft 1 has a fuselage 2 having a fore end at which a cockpit is located, and an aft end supporting a tail assembly, with the cabin generally located between the cockpit and the tail assembly. The tail assembly comprises a vertical stabilizer 3 with a rudder, and horizontal stabilizers 4 with elevators. The tail assembly has a fuselage-mounted tail, but other configurations may also be used for the aircraft 1, such as cruciform, T-tail, etc. Wings 5 extend laterally from the fuselage. The aircraft 1 has engines 6 supported by the wings 5. The aircraft 1 is shown as a jet-engine aircraft, but may also be a propeller aircraft. It is also understood that although FIG. 1 shows a commercial aircraft, the aircraft 1 may alternately be any other type of aircraft, including, but not limited to, a business aircraft or a private aircraft.

Each of the wings 5 extends from a root 5a adjacent the fuselage 2 to a tip 5b, and each of the engines 6 is disposed between the root 5a and the tip 5b and below a respective one of the wings 5. The engines 6, which include nacelles 6a, are supported below the wings 5 via pylons 10 each surrounded by a pylon fairing 100 defining the surface exposed to the airflow. It is understood that the whole or a part of the fairing 100 may be an integral part of the pylon, for example defined by the pylon skin, and/or that the whole or a part of the fairing may be defined by one or more element(s) formed separately from the pylon 10 and installed around the pylon 10. Accordingly, the term “fairing” as used herein is not intended to be limited to a structure separate from the pylon 10. The pylon fairing 100 is typically streamlined and, in a particular embodiment, is designed to minimize friction losses that might otherwise occur if the pylon 10 were exposed to ambient air circulating around the aircraft 1. In other words, the pylon fairing 100 is used to hide structural hard points associated with the engine attachment to the wing 5. The pylon fairing 100 is typically designed to be wider at a wing junction compared to a remainder of the pylon fairing 100.

For an under-wing mounted engine aircraft as illustrated in FIG. 1, there is a strong interaction between the aerodynamic flow around the wing 5, the engines 6, and the pylon fairing 100 that might result in lift loss (i.e., interference effect). In a particular embodiment, the pylon fairing 100 has an aerodynamic design adapted to minimize adverse flow interactions between the nacelles 6a and the wings 5. As the engine fan diameter is increased, the interference effects become more pronounced. For a closely coupled engine to airframe installation, the interaction of a jet exiting the engine with the pylon fairing 100 and the wing 5 might introduce additional lift loss and an increase in aircraft drag. It may also result in appearance of flow separation at a junction between the pylon fairing 100 and the wing 5. Such a flow separation might be an additional source of aircraft drag, which may result in a decrease in aircraft performance.

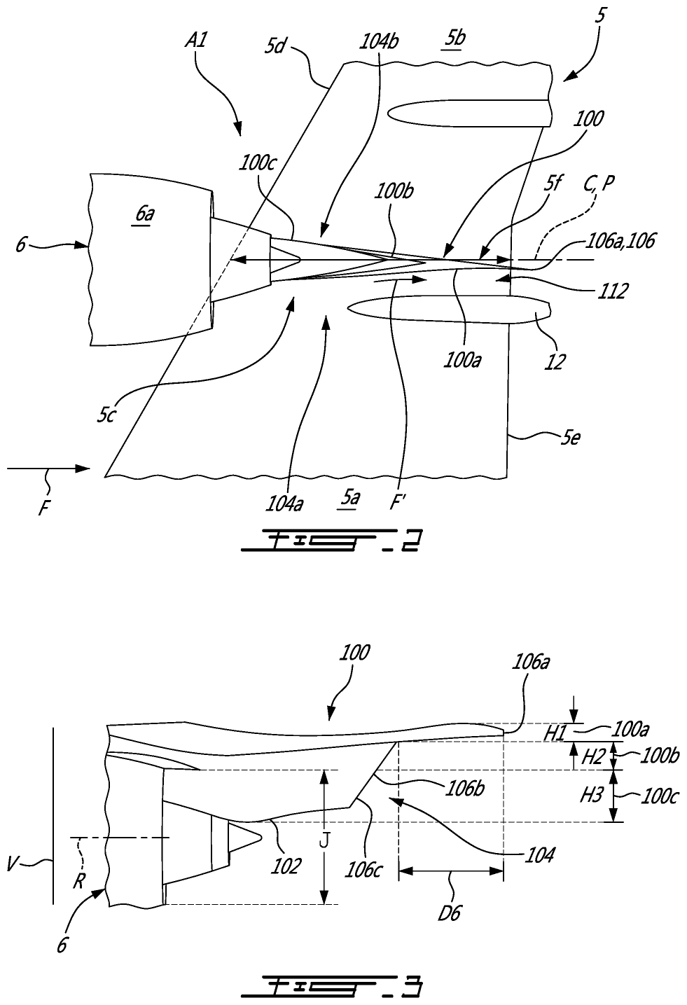

Referring now to FIGS. 2 to 6, an assembly Al in accordance with a particular embodiment is illustrated, including the wing 5 and a pylon fairing 100 defining the exposed surface of the pylon 10. As can be best seen in FIG. 3, the pylon fairing 100 extends from the wing 5 and has a shelf 102 configured to be adjacent to the engine 6 and exposed to the jet J (FIG. 3) generated by the engine 6. The pylon fairing 100 extends along a pylon span-wise axis V, along which a height of the pylon fairing 100 is defined. The pylon span-wise axis V is normal to the wing chord. As can be best seen in FIG. 4, the pylon fairing 100 has an aerodynamic profile 104, which may be configured for example in whole or in part by an airfoil shape. The profile 104 is defined by opposed inward and outward sides or walls 104a, 104b, with the inward side 104a facing the root 5a of the wing 5 and the fuselage 2 (FIG. 1). The inward and outward sides 104a and 104b meet to define a fairing trailing edge 106.

Referring now to FIG. 2, the wing 5 has a leading edge 5d and a trailing edge 5e between which a plurality of local chord lines can be defined. It is understood that the trailing edge 5e may be defined by a fixed part of the wing 5, or, when trailing edge flaps are present, by the trailing edge of the flap. In the embodiment shown, distances between the leading and trailing edges 5d, 5e of the wing 5 along the chord lines vary from the root 5a to the tip 5b of the wing 5. The pylon fairing 100 is adjacent to or abutting the wing 5 at a pylon location 5c located between the root 5a and the tip 5b of the wing 5, and a local chord line 5f is defined at the pylon location 5c. In the embodiment shown, the pylon location 5c is located outward of but close to a flap track fairing 12 disposed around a mechanism used to deploy and retract the wing flaps, and accordingly the trailing edge 5e of the wing 5 at the pylon location 5c is determined by the flap. The interaction of the pylon fairing 100, the wing 5, and the flap track fairing 12 creates a flow channel 112 that might be subjected to fluidic phenomenon that impair performances.

Referring more particularly to FIG. 3, the pylon fairing 100 has an upper section 100a, a central section 100b, and a lower section 100c, with the central section 100b located between the upper and lower sections 100a, 100c relative to the pylon span-wise axis V. The upper section 100a is located adjacent the wing 5 and extends downwardly, i.e. toward the shelf 102. The central section 100b extends downwardly from the upper section 100a. In the embodiment shown, the transition between the upper section 100a and central section 100b is defined by an abrupt change in length of the fairing 100 as defined by an abrupt change in location of the fairing trailing edge 106. The lower section 100c extends downwardly from the central section 100b, adjacent the engine 6, and includes the shelf 102. In a particular embodiment, the transition between the central section 100b and the lower section 100c is defined by a change in camber and/or lateral offset, as will be further detailed below. In a particular embodiment, the lower section 100c includes and is limited to the portion of the fairing 100 defining the shelf 102, i.e. extending through the jet or flow J generated by the engine 6. In the embodiment shown, the flow channel 112 (FIG. 2) is defined more specifically between the flap track fairing 12 and the upper section 100a of the pylon fairing 100. It is understood that two or all of the sections 100a, 100b, 100c may be monolithic and formed as a single piece, and that alternately the sections 100a, 100b, 100c may be formed separately and positioned adjacent one another along the height of the pylon 10.

In a particular embodiment and referring to FIG. 3, a height H1 of the upper section 100a defined between the wing 5 and the central section 100b along the pylon span-wise axis V has a value ranging from 2.5% to 10% of the local chord 5f of the wing taken at the pylon location 5c. A height H2 of the central section 100b defined between the upper section 100a and the lower section 100c along the pylon span-wise axis V has a value ranging from 10% to 17% of the local chord 5f of the wing 5. A height H3 of the lower section 100c defined from the central section 100b has a value ranging from 17% to 23% of the local chord 5f of the wing 5. Other values are also possible.

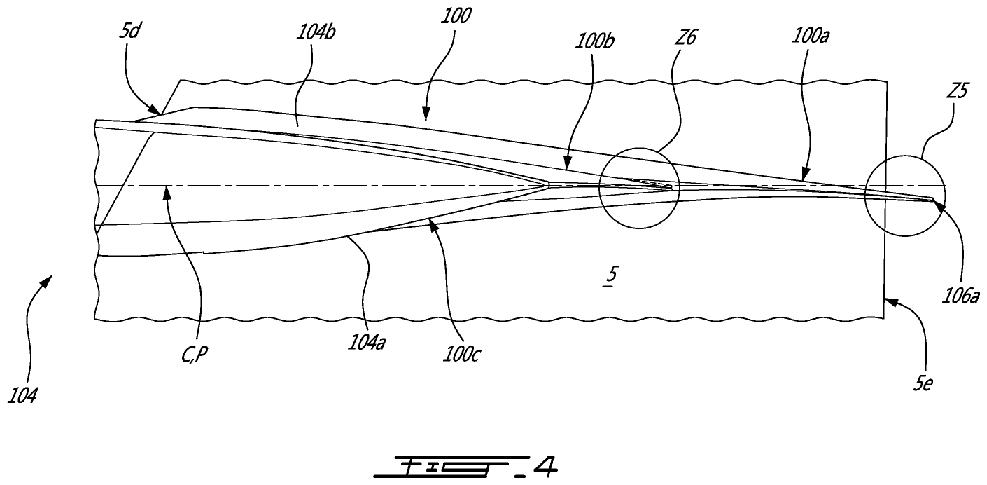

In a particular embodiment, the aerodynamic profile 104 defined by the inward and outward sides 104a, 104b in at least part of, and in a particular embodiment a whole of, the lower section 100c is symmetrical. Referring to FIGS. 2-3, the engine has a longitudinal central axis R (FIG. 3), and an engine vertical mid-plane P (FIG. 2) which is defined as the plane containing the central axis R and oriented vertically when the aircraft is on the ground and the engine 6 is installed on the aircraft. Referring to FIGS. 4-5, at least a part of, and in a particular embodiment a whole of, the lower section 100c of the pylon fairing 100 has a chord line C parallel to the longitudinal central axis R of the engine 6 and extending in the engine vertical mid-plane P, and the fairing trailing edge 106c (FIG. 3) in at least a part of, and in a particular embodiment a whole of, the lower section 100c is contained within the engine vertical mid-plane P.

Still referring to FIGS. 4-5, in the embodiment shown the fairing trailing edge 106a in the upper section 100a protrudes axially rearward of the trailing edge 5e of the wing 5 at the pylon location 5c. In the embodiment shown and as can be seen in FIG. 5, a distance D1 is defined along the direction of the chord line C of the lower section (or engine axis R, see FIG. 3) between the trailing edge 5e of the wing 5 and the fairing trailing edge 106a in the upper section 100a at the pylon location 5c; the distance D1 is defined at the position of the flap defining the rearmost leading edge for the wing. In a particular embodiment, the distance D1 is at least 3% and/or at most 13% of the local chord 5f of the wing at the pylon location 5c, for example at least 5% and/or at most 10% of the local chord 5f of the wing at the pylon location 5c. Other values are also possible. In the embodiment shown, the axial distance D1 between the wing trailing edge 5e and the fairing trailing edge 106 remains the same along the height of the upper section 100a.

In a particular embodiment, the fairing trailing edge 106a in the upper section 100a protruding axially rearwardly of the trailing edge 5e of the wing 5 at the pylon location 5c is particularly suitable for high cruise speeds, for example cruise speeds of Mach 0.82 and higher. Other values are also possible.

Still referring to FIGS. 4-5, in the embodiment shown, the aerodynamic profile 104 defined by the inward and outward sides 104a, 104b of the upper section 100a of the pylon fairing 100 is cambered toward the root 5a of the wing 5, and toward the adjacent flap track fairing 12. Accordingly, the fairing trailing edge 106a in the upper section 100a is located between the engine vertical mid-plane P and the root 5a of the wing 5, and is offset from the engine vertical mid-plane P by an offset distance D2 (FIG. 5) taken perpendicularly from the engine vertical mid-plane P. In a particular embodiment, the offset distance D2 has a value of at least 0.3% and/or at most 6.5% of the local chord 5f of the wing at the pylon location 5c, for example at least 0.5% and/or at most 3% of the local chord 5f of the wing at the pylon location 5c. Other values are also possible.

In the embodiment shown and referring to FIG. 3, the fairing trailing edge 106b in the central section 100b is forwardly offset from the fairing trailing edge 106a in the upper section 100a, for example by a distance D6. In a particular embodiment, the distance D6 has a value of 34% or about 34% of the local chord 5f of the wing at the pylon location 5c. Other values are also possible. The fairing trailing edge 106b in the central section 100b is located forward of the wing trailing edge 5e. Referring to FIG. 6, in a particular embodiment the aerodynamic profile 104 defined by the inward and outward sides 104a, 104b in the central section 100b is also cambered toward the root 5a of the wing 5. The fairing trailing edge 106b in the central section 100b is offset from the engine vertical mid-plane P by an offset distance D5. In a particular embodiment, the offset distance D5 has a value of at least 0.3% and/or at most 3% of the local chord 5f of the wing 5 at the pylon location 5c, for example at least 0.5% and/or at most 2% of the local chord 5f of the wing at the pylon location 5c. Other values are also possible. For example, in a particular embodiment the central section 100b is symmetrical and/or the fairing trailing edge 106b in the central section 100b is located within the engine vertical mid-plane P.

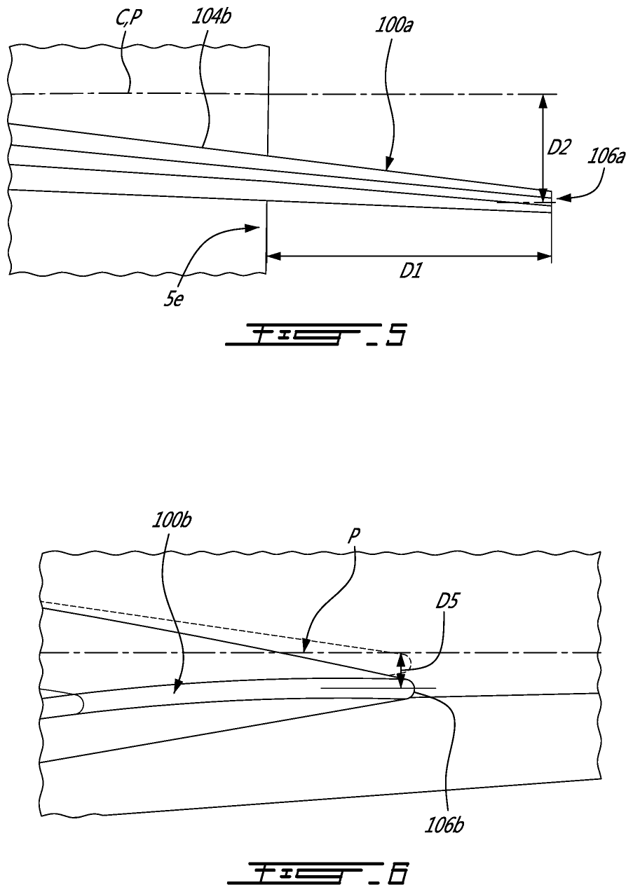

Referring more particularly to FIG. 7, a graph illustrating a variation of the offset distance D2 between the fairing trailing edge 106 and the engine vertical mid-plane P as a function of a distance from the wing 5 along the pylon span-wise axis V is presented. In the present graph, both the offset distance D2 and the distance from the wing 5 are expressed as percentages of the local chord 5f of the wing 5 at the pylon location 5c. In the embodiment shown, the offset distance D2 remains constant in the upper section 100a, and then decreases progressively as the distance from the wing increases until it reaches a value of 0 in the lower section 100c, where the fairing trailing edge 106c is located within the engine vertical mid-plane P. Other configurations are contemplated.

Referring more particularly to FIG. 8, a graph illustrating a variation of an absolute value of the axial distance D1 (i.e. whether forward or aft of) between the fairing trailing edge 106 and the trailing edge 5e of the wing 5 as a function of a distance from the wing 5 along the pylon span-wise axis V is presented. In the present graph, both the axial distance D1 and the distance from the wing 5 are expressed as percentages of the local chord 5f of the wing 5. In the embodiment shown, the axial distance D1 remains constant in the upper section 100a, and then changes abruptly between the upper section 100a and the central section 100b. The axial distance D1 then increases progressively as the distance from the wing increases. Other configurations are contemplated.

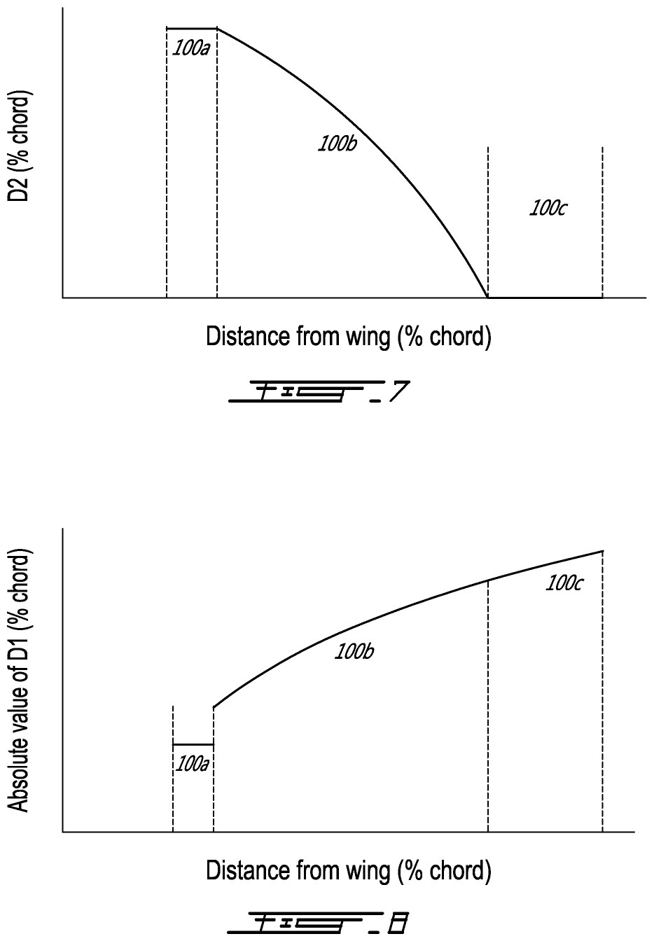

Referring now to FIGS. 9 to 11, an assembly A2 in accordance with another embodiment is shown, including the wing 5 and a pylon fairing 200, where elements similar to that of the pylon fairing 100 of FIGS. 2 to 6 are identified by the same reference numerals and will not be further described herein.

In this embodiment, the fairing trailing edge 206a in the upper section 200a is located axially forward of the trailing edge 5e of the wing 5 at the pylon location 5c. In a particular embodiment, the axial distance D1 (FIG. 10) between the trailing edge 5e of the wing 5 and the fairing trailing edge 206a at the pylon location 5c is at most 30%, and preferably at most 25%, of the local chord 5f of the wing 5 at the pylon location 5c. Other values are also possible. For example, the fairing trailing edge 206a at the pylon location 5c may overlap a flap the wing, i.e. be located rearwardly of a junction between the flap and the wing 5 and forwardly of a trailing edge of the flap. It is understood that the values for the axial distance D1 mentioned for the upper section 100a can be applied to the upper section 200a, and that the values for the axial distance D1 mentioned for the upper section 200a can be applied to the upper section 100a. In a particular embodiment, the fairing trailing edge 206a in the upper section 200a is axially aligned with the trailing edge 5e of the wing 5 at the pylon location 5c, i.e. the axial distance D1 is 0 for part or a whole of the upper section 200a.

As illustrated in FIG. 10, the fairing trailing edge 206a at a lowermost end of the upper section 200a is axially aligned with the fairing trailing edge 106b at an uppermost end of the central section 100b; for example, in a particular embodiment there is no distinct transition between the upper section 200a and the central section 100b. In a particular embodiment, the axial distance D1 between the fairing trailing edge and the trailing edge 5e of the wing 5 varies at a constant rate, and/or the trailing edge 206a shows continuity, e.g. tangent continuity, with the fairing trailing edge 106b.

In this embodiment and referring more particularly to FIG. 9, the aerodynamic profile 104 defined by the inward and outward sides 104a, 104b in the upper section 200a of the pylon fairing 200 is also cambered toward the root 5a of the wing 5. The offset distance D2 may be defined similarly to that of the pylon fairing 100 as shown in FIG. 5, and in a particular embodiment may have the same values or ranges of values. In another embodiment, the offset distance D2 of the upper section has a value of at least 0.3% and/or at most 3% of the local chord 5f of the wing at the pylon location 5c, for example at least 0.5% and/or at most 2% of the local chord 5f of the wing at the pylon location 5c. Other values are also possible.

In a particular embodiment, the aerodynamic profile 104 defined by the inward and outward sides 104a, 104b in the central section 100b of the fairing 200 is also cambered toward the root 5a of the wing 5, with the fairing trailing edge 106b in the central section 100b offset from the engine vertical mid-plane P by an offset distance which may correspond to the values of D5 provided above. Alternately, the central section 100b of the fairing 200 may be symmetrical and/or the fairing trailing edge 106b in the central section 100b of the fairing 200 may be located within the engine vertical mid-plane P.

In a particular embodiment, the aerodynamic profile 104 defined by the inward and outward sides 104a, 104b in the lower section 100c of the fairing 200 is symmetrical, and/or the fairing trailing edge 106c in the lower section 100c of the fairing 200 is located within the engine vertical mid-plane P.

In a particular embodiment, the pylon fairings 100, 200 allow to improve a flow quality at the fairing trailing edge 106a, 206a and to reduce the drag compared to uncambered and/or shorter pylon configurations. In a particular embodiment, the pylon fairings 100, 200 allow to reduce a possible flow separation at the fairing trailing edge 106a, 206a by accelerating the flow in the channel 112 defined between the pylon fairing 100, 200 and the wing 5, more particularly between the pylon fairing 100, 200 and the flap track fairing 12 (FIG. 2), and by modifying the wing pressure distribution in the vicinity of the pylon fairing 100, 200.

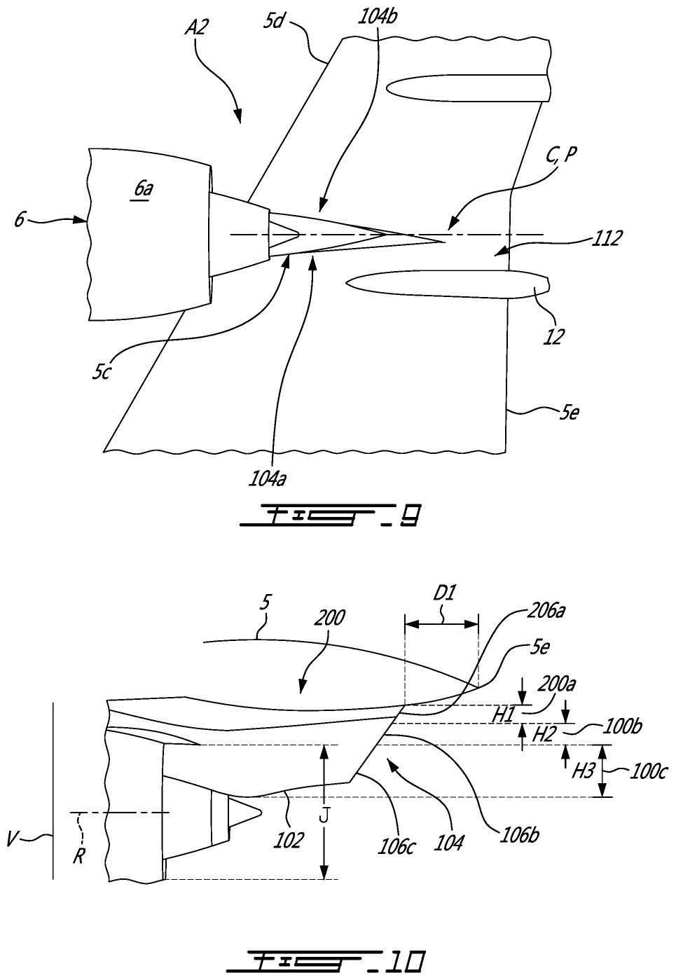

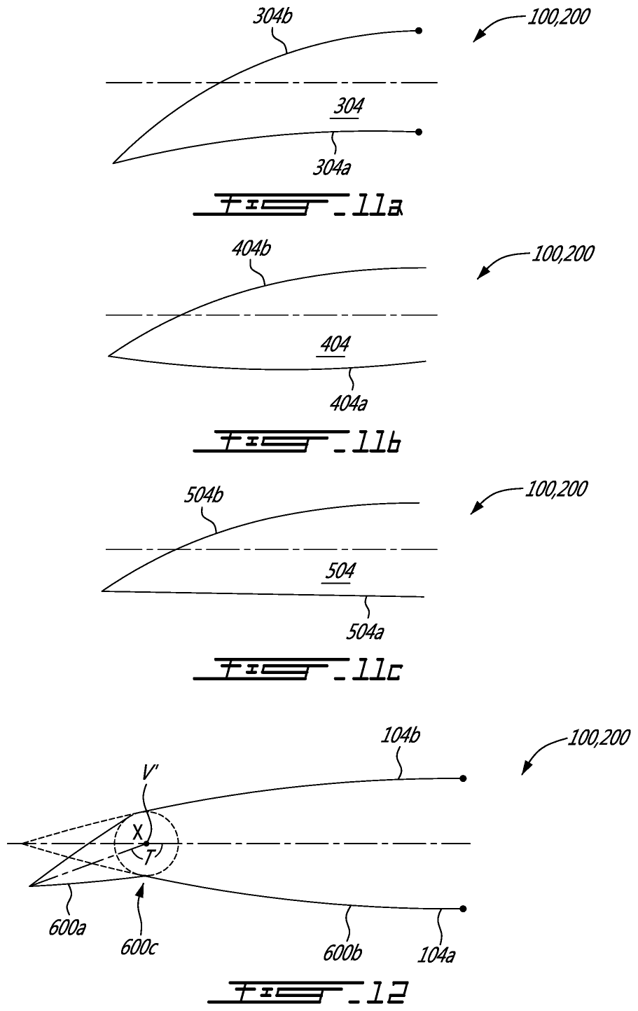

Referring now to FIGS. 11a to 11c, alternate aerodynamic profiles 304, 404, 504 that can be used for the pylon fairings 100, 200 are illustrated. The aerodynamic profiles 304, 404, 504 are each defined by an inward side 304a, 404a, 504a, and by an opposed outward side 304b, 404b, 504b, with the inward side 304a, 404a, 504a facing the fuselage 2 (FIG. 1). In the embodiment of FIG. 11a, the outward side 304b is convex and the inward side 304a is concave. Alternately, and as shown in FIG. 11b, both the inward and outward sides 404a, 404b are convex. Alternately, and as shown in FIG. 11c, the outward side 504b is convex whereas the inward side 504a is flat and has no curvature. Any one of these combinations can be used to obtain the desired offset D2 for the fairing trailing edge 106a, 206a in the upper section 100a, 200a.

Referring now to FIG. 12, in an alternate embodiment the pylon fairing 100, 200 may have a trailing section 600a pivotally mounted to a body 600b via a pivot point 600c to be able to pivot relative to the body 600b about an axis V′. A flap mechanism (not shown) is provided to control movements of the trailing section 600a relative to the body 600b, and the trailing section 600a and body 600b cooperate together to define the inward and outward sides 104a, 104b. Stated otherwise, the mechanism is configured to control an angle T between the trailing section 600a and the body 600b so as to obtain the desired offset D2 for the fairing trailing edge 106a, 206a in the upper section 100a, 200a. In a particular embodiment, this configuration allows the optimization of an angular position of the trailing section 600a relative to the body 600b in function of the flight operating conditions.

In a particular embodiment and in use, directing the airflow denoted by arrow F on FIG. 2 around the aircraft 1 between the wing 5 and the engine 6 includes guiding the airflow toward the trailing edge 5e of the wing 5 between the pylon and the fuselage 2 with the pylon fairing 100, 200. In the embodiments shown, guiding the flow includes deviating an upper portion of the airflow F located adjacent the wing 5 and denoted by arrow F′ on FIG. 2 toward the fuselage 2 with the pylon fairing 100, 200. The pylon fairing 100, 200 deviates the flow up to the trailing edge 106a, 206a of the pylon fairing 100, 200 that is distanced from the trailing edge 5e of the wing 5 by at most 30% of the local chord of the wing 5 at the pylon location 5c, for example positioned in front of the trailing edge 5e of the wing 5 at a distance from the trailing edge 5e of at most 30% or at most 25% of the local chord of the wing 5, or positioned aft of the trailing edge 5e of the wing 5 at a distance from the trailing edge 5e of at least 3% and/or at least 5% and/or at most 13% and/or at most 10% of the local chord 5f of the wing at the pylon location 5c. The upper portion F′ (FIG. 2) of the flow circulates within the channel 112. In the embodiment of FIGS. 2-8, the pylon fairing 100 deviates the flow F past the trailing edge 5e of the wing 5.

In a particular embodiment, a maximum deviation of the flow toward the fuselage 2 is achieved in a vicinity of the wing 5, and adjacent the upper sections 100a, 200a of the pylon fairings 100, 200. The flow deviation decreases when a distance from the wing 5 along the pylon span-wise axis V increases. A portion of the jet J generated by the engine 6 is guided toward a direction parallel the central axis R of the engine by the pylon fairing.

While the methods and systems described herein have been described and shown with reference to particular steps performed in a particular order, it will be understood that these steps may be combined, subdivided or reordered to form an equivalent method without departing from the teachings of the present invention. Accordingly, the order and grouping of the steps is not a limitation of the present invention.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1. An assembly for an aircraft comprising:
a wing having a root configured to be adjacent a fuselage of the aircraft; and
a pylon fairing extending from the wing at a pylon location spaced from the root, the pylon fairing having an aerodynamic profile defining a fairing trailing edge, an upper section adjacent the wing, and a lower section configured to be adjacent an engine of the aircraft, the lower section including a shelf configured for extending through a jet generated by the engine;
wherein the aerodynamic profile in the upper section of the pylon fairing is cambered toward the root of the wing;
wherein the aerodynamic profile in at least part of the lower section of the pylon fairing is symmetrical; and
wherein the fairing trailing edge in the upper section of the pylon protrudes rearwardly of a trailing edge of the wing at the pylon location.

2. The assembly of claim 1, wherein the at least part of the lower section of the fairing has a chord line configured to be parallel to a central axis of the engine, the fairing trailing edge in the upper section being offset from a plane containing the chord line of the lower section and the central axis of the engine by an offset distance having a value corresponding to at least 0.3% of a local chord of the wing at the pylon location.

3. The assembly of claim 2, wherein the value of the offset distance between the fairing trailing edge in the upper section and the plane corresponds to at most 6.5% of the local chord of the wing at the pylon location.

4. The assembly of claim 1, wherein a value of a distance between the trailing edge of the wing and the fairing trailing edge at the pylon location corresponds to at least 3% of a local chord of the wing at the pylon location.

5. The assembly of claim 4, wherein the value of the distance between the trailing edge of the wing and the fairing trailing edge at the pylon location corresponds to at most 13% of the local chord of the wing at the pylon location.

6. The assembly of claim 1, wherein the pylon fairing has opposed inward and outward sides with the inward side facing the root of the wing, the outward side of the upper section of the pylon fairing being convex and the inward side of the upper section of the pylon fairing being concave.

7. The assembly of claim 1, wherein the pylon fairing further comprises a central section between the upper and the lower sections, the central section cambered toward the root of the wing, the fairing trailing edge in the central section being forwardly offset from the fairing trailing edge in the upper section.

8. The assembly of claim 7, wherein a height of the upper section defined from the wing to the central section has a value corresponding to at least 2.5% of a local chord of the wing at the pylon location.

9. The assembly of claim 8, wherein the value of the height of the upper section is at most 10% of the local chord of the wing at the pylon location.

10. An assembly for an aircraft comprising:
a wing having a root configured to be adjacent a fuselage of the aircraft; and
a pylon fairing extending from the wing at a pylon location spaced from the root, the pylon fairing having an aerodynamic profile defining a fairing trailing edge, an upper section extending from the wing, and a lower section configured to be adjacent an engine of the aircraft and including a shelf configured for extending through a jet generated by the engine;
wherein at least part of the lower section of the fairing has a chord line configured to extend in an engine vertical mid-plane of the engine, the fairing trailing edge in the at least part of the lower section being contained within the engine vertical mid-plane;
wherein the fairing trailing edge in the upper section is offset from the engine vertical mid-plane and located between the engine vertical mid-plane and the root of the wing; and
wherein a distance between the fairing trailing edge in the upper section and a trailing edge of the wing at the pylon location has a value corresponding to at most 30% of a local chord of the wing at the pylon location.

11. The assembly of claim 10, wherein the fairing trailing edge in the upper portion is offset from the engine vertical mid-plane by an offset distance having a value corresponding to at least 0.3% of the local chord of the wing at the pylon location.

12. The assembly of claim 11, wherein the value of the offset distance between the fairing trailing edge in the upper portion and the engine vertical mid-plane corresponds to at most 6.5% of the local chord of the wing at the pylon location.

13. The assembly of claim 10, wherein the fairing trailing edge in the upper section is located forward of the trailing edge of the wing.

14. The assembly of claim 10, wherein the fairing trailing edge in the upper section is axially aligned with the wing trailing edge at the pylon location.

15. The assembly of claim 10, wherein the pylon fairing has opposed inward and outward sides with the inward side facing the root of the wing, the outward side of the upper section of the pylon fairing being convex and the inward side of the upper section of the pylon fairing being concave.

16. The assembly of claim 10, wherein the pylon fairing further comprises a central section between the upper and the lower sections, the central section cambered toward the root of the wing, the fairing trailing edge in the central section forwardly offset from the fairing trailing edge in the upper section and from the trailing edge of the wing.

17. The assembly of claim 10, wherein the value of the distance between the trailing edge of the wing and the fairing trailing edge at the pylon location corresponds to at least 3% of the local chord of the wing at the pylon location.

18. The assembly of claim 10, wherein the value of the distance between the trailing edge of the wing and the fairing trailing edge at the pylon location corresponds to at most 13% of the local chord of the wing at the pylon location.

19. A method of directing an airflow around an aircraft between a wing of the aircraft and an engine connected to the wing, comprising:
guiding the airflow toward a trailing edge of the wing between a pylon supporting the engine and a fuselage of the aircraft with a fairing of the pylon, wherein guiding the airflow includes:
deviating an upper portion of the airflow adjacent the wing toward the fuselage with the fairing, the pylon fairing deviating the flow up to a trailing edge of the pylon fairing spaced rearwardly from the trailing edge of the wing, and
guiding a portion of a jet generated by the engine with the fairing along a direction parallel to a central axis of the engine.

20. The method of claim 19, wherein a value of a distance between the trailing edge of the wing and the fairing trailing edge adjacent the wing corresponds to at least 3% of a local chord of the wing adjacent the pylon.
